(19) United States
(12) Patent Application Publication
(10) Pub. No.: US 2019/0012045 A1
(43) Pub. Date: Jan. 10, 2019

(54) SEAMLESS WORKFLOW BETWEEN MOBILE APPLICATIONS ON PORTABLE DEVICE

(71) Applicant: MOTOROLA SOLUTIONS, INC., Chicago, IL (US)

(72) Inventors: Tal Gilor, Kefar Truman (IL); Eitan Koren, Raanana (IL)

(21) Appl. No.: 15/641,802

(22) Filed: Jul. 5, 2017

(51) Int. Cl. G06F 3/0482; H04M 1/725; G06F 3/147; G06F 3/0488

(52) U.S. Cl. CPC G06F 3/0482; H04M 1/72522; G06F 3/0485; G06F 3/04883; G06F 3/147

(57) ABSTRACT

Device and method for seamless workflow between mobile applications on portable device. One device includes a display and an electronic processor. The electronic processor is configured to associate a set of applications to each other within a folder stored on the device and assign each application a priority relative to the other applications. The electronic processor is configured to receive a first user input selecting the folder and activate the set of applications in a background of an operating system of the portable device and present a first indication of a first application based on the priority of the first application relative to the other applications. The electronic processor is configured to receive a second user input; and navigate to a first indication of a second application based on the priority of the second application relative to the other applications and a navigation direction.

### BACKGROUND OF THE INVENTION

Workers (for example, public safety personnel, utility workers, and construction workers) responding to individual task requests (for example, incident reports, calls for service, and work orders) may use portable electronic devices to assist them during the performance of their duties. Some portable electronic devices, for example smart telephones, provide a suite of applications that interact with and consume data from computer systems that coordinate work and assign tasks to workers (for example, computer-aided dispatch systems and workflow ticketing systems). Such application suites offer workers access to many potentially relevant applications while responding to task requests.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a portable electronic device in accordance with some embodiments.

FIG. 2 is a flowchart of a method of navigation between applications on the portable electronic device of FIG. 1 in accordance with some embodiments.

FIG. 3A illustrates an example graphical user interface (“GUI”) folder screen.

FIG. 3B illustrates an example graphical user interface folder identifier screen.

FIG. 3C illustrates an example graphical user interface folder association screen.

FIG. 3D illustrates an example graphical user interface application priority screen.

FIG. 3E illustrates an example graphical user interface gesture method selection screen.

FIG. 3F illustrates an example graphical user interface gesture configuration screen.

FIG. 3G illustrates an example graphical user interface scrolling selection screen.

FIG. 4 is a diagram illustrating navigation between applications on the portable electronic device of FIG. 1.

FIG. 5A illustrates a graphical user interface screen for the portable electronic device of FIG. 1 in accordance with some embodiments.

FIG. 5B illustrates a graphical user interface screen for the portable electronic device of FIG. 1 in accordance with some embodiments.

FIG. 6 illustrates a group of related users of the portable device of FIG. 1.

FIG. 7 is a flowchart of a method of sharing navigation between applications in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The device and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Typically, switching to a different application while operating in another application on a portable electronic device requires opening and navigating a menu before selecting the desired application. This may be distracting or time consuming, particularly for emergency personnel who may need to use several applications during an emergency situation. In addition, emergency personnel may be able to put time spent switching between applications to better use in response activities. Accordingly, methods and systems are provided herein for application navigation on a portable device.

One example embodiment provides a portable device. The device includes a display and an electronic processor coupled to the display. The electronic processor is configured to associate a set of applications to each other within a folder stored on the portable device and assign each application of the set of applications a priority relative to the other applications of the set of applications. The electronic processor is further configured to receive, via an interface of the portable device, a first user input selecting the folder and in response to receiving the first user input, activate the set of applications in a background of an operating system of the portable device and present, via the display, a first indication of a first application of the set of applications based on the priority of the first application relative to the other applications of the set of applications. The electronic processor is also configured to receive, via the interface of the portable device, a second user input; and in response to receiving the second user input, navigate to a first indication of a second application of the set of applications based on the priority of the second application relative to the other applications of the set of applications and a navigation direction associated with the second user input.

Another example embodiment provides a method of application navigation on a portable device. The method includes associating a set of applications to each other within a folder stored on the portable device and assigning each application of the set of applications a priority relative to the other applications of the set of applications. The method also includes receiving, via an interface of the portable device, a first user input selecting the folder and in response to receiving the first user input, activating the set of applications in a background of an operating system of the portable device and presenting a first indication of a first application of the set of applications based on the priority of the first application relative to the other applications of the set of applications. The method also includes receiving, via the interface of the portable device, a second user input including a gesture and in response to receiving the second user input, navigating to a second indication of a of a second application of the set of applications based on the priority of the second application relative to the other applications of the set of applications and a navigation direction associated with the second user input.

For ease of description, some or all of the example systems presented herein are illustrated with a single exemplar of each of its component parts. Some examples may not describe or illustrate all components of the systems. Other example embodiments may include more or fewer of each of the illustrated components, may combine some components, or may include additional or alternative components.

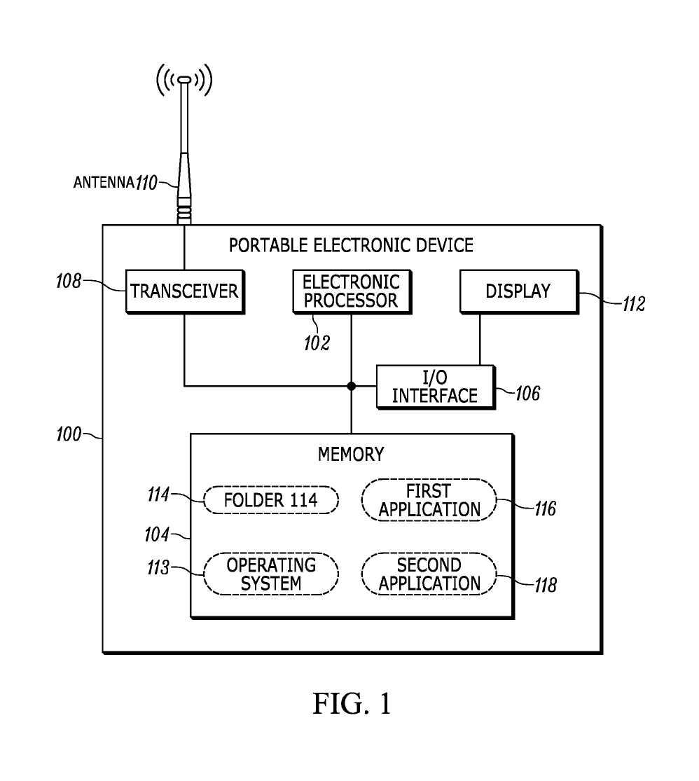

FIG. 1 is a diagram of an example of the portable electronic device 100. In the embodiment illustrated, the portable electronic device 100 includes an electronic processor 102, a memory 104, an input and output interface 106, a transceiver 108, an antenna 110, and a display 112. The illustrated components, along with other various modules and components are coupled to each other by or through one or more control or data buses that enable communication therebetween. The use of control and data buses for the interconnection between and exchange of information among the various modules and components would be apparent to a person skilled in the art in view of the description provided herein.

The electronic processor 102 obtains and provides information (for example, from the memory 104 and/or the input and output interface 106), and processes the information by executing one or more software instructions or modules, capable of being stored, for example, in a random access memory (“RAM”) area of the memory 104 or a read only memory (“ROM”) of the memory 104 or another non-transitory computer readable medium (not shown). The software can include firmware, one or more applications, program data, filters, rules, one or more program modules, and other executable instructions.

The memory 104 can include one or more non-transitory computer-readable media, and includes a program storage area and a data storage area. The program storage area and the data storage area can include combinations of different types of memory, as described herein. In the embodiment illustrated, the memory 104 stores, among other things, an operating system 113 of the portable electronic device 100, a folder 114, a first application 116, and a second application 118 (described in detail below). The electronic processor 102 is configured to retrieve from the memory 104 and execute, among other things, software related to the control processes, for example, the operating system 113 and the first and second application 116, 118, and methods described herein.

The input and output interface 106 is configured to receive input and to provide output to peripherals. The input and output interface 106 obtains information and signals from, and provides information and signals to, (for example, over one or more wired and/or wireless connections) devices both internal and external to the portable electronic device 100.

The electronic processor 102 is configured to control the transceiver 108 to transmit and receive data to and from the portable electronic device 100. The electronic processor 102 encodes and decodes digital data sent and received by the transceiver 108. The transceiver 108 transmits and receives radio signals to and from various wireless communications networks using the antenna 110. The electronic processor 102 and the transceiver 108 may include various digital and analog components, which for brevity are not described herein and which may be implemented in hardware, software, or a combination of both. Some embodiments include separate transmitting and receiving components, for example, a transmitter and a receiver, instead of a combined transceiver 108.

The display 112 is a suitable display, for example, a liquid crystal display (LCD) touch screen, or an organic light-emitting diode (OLED) touch screen. The portable electronic device 100 implements a graphical user interface (GUI) (for example, generated by the electronic processor 102, from instructions and data stored in the memory 104, and presented on the display 112), that enables a user to interact with the portable electronic device 100. The graphical user interface presented herein allows interaction with the interface using gesture-based inputs. Embodiments presented herein are described in terms of gestures received by a touch screen interface. However, in other embodiments, gestures could be captured via a cursor-control device and through input actions such as mouse clicks. Thus, a touch screen is not necessary in all instances.

In some embodiments, the portable electronic device 100 is a smart phone. In other embodiments, the portable electronic device 100 may be a tablet computer, a smart watch, a portable radio, a combination of the foregoing, or another portable or mobile electronic device containing software and hardware enabling it to operate as described herein.

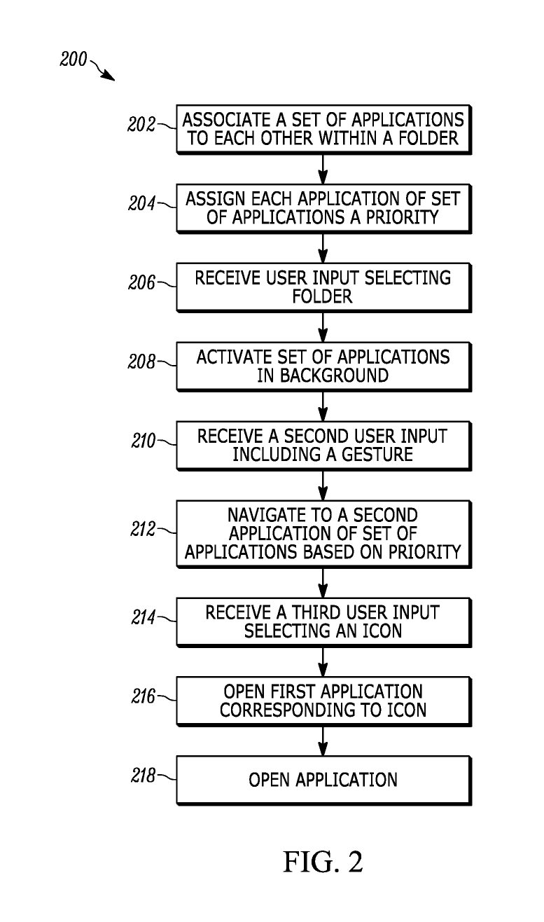

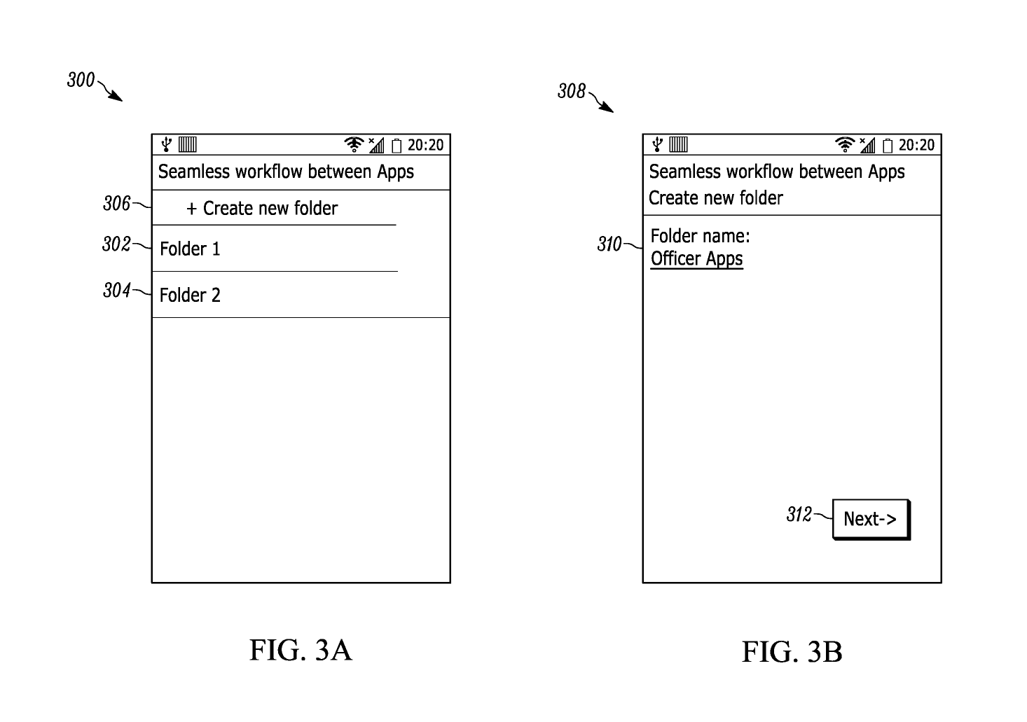

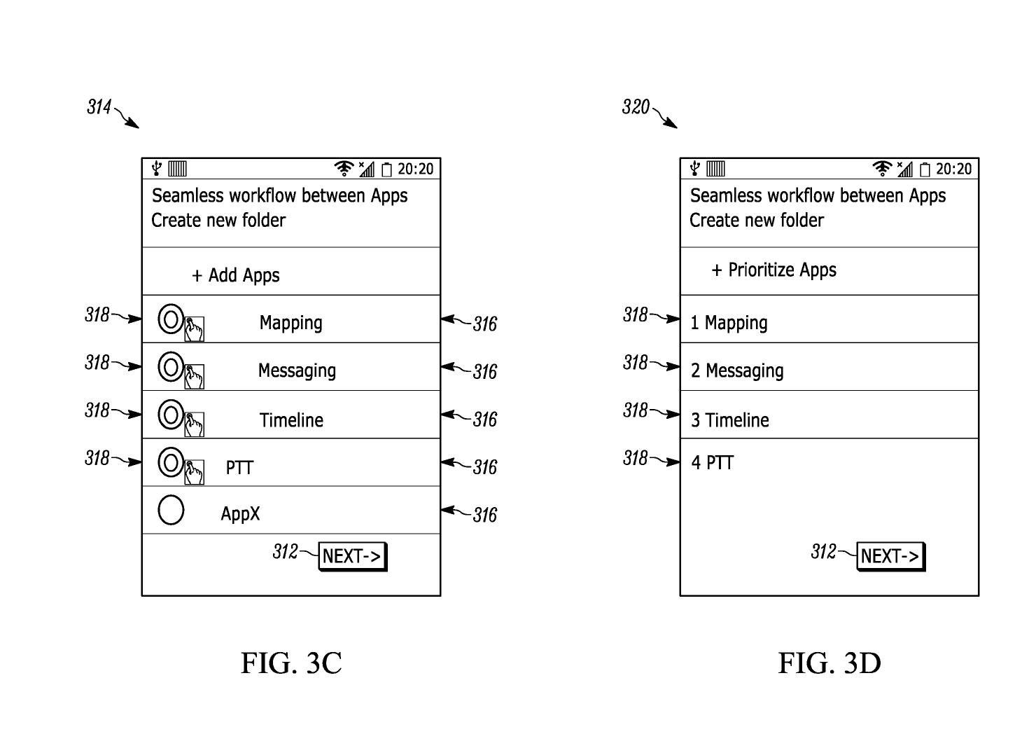

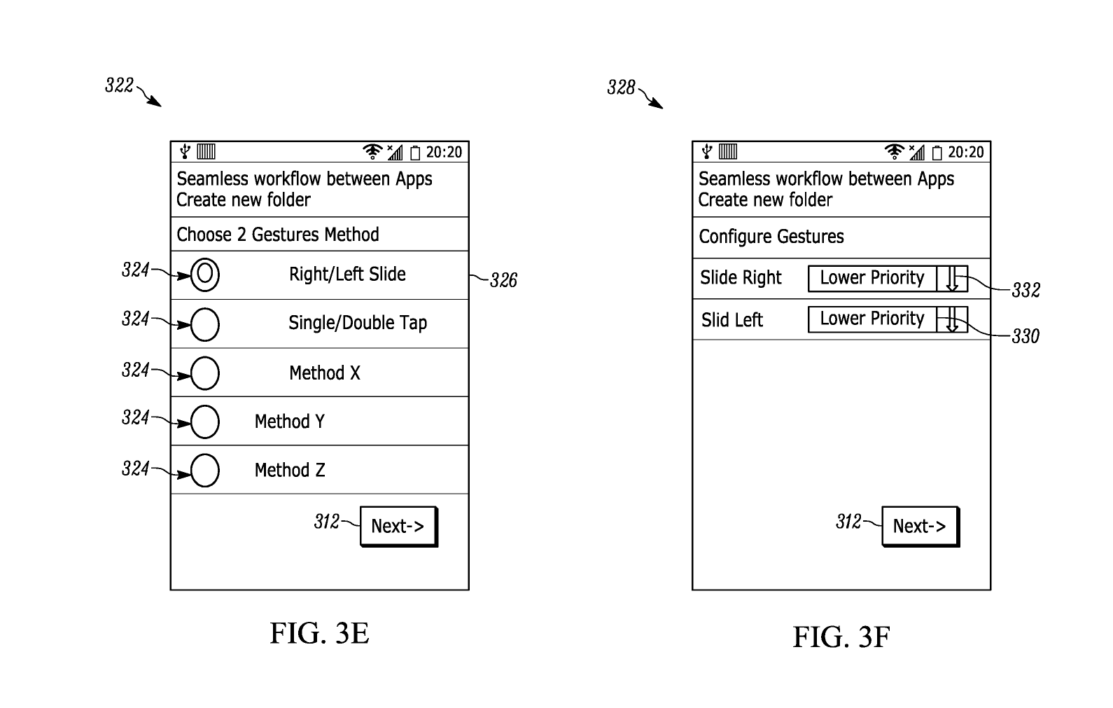

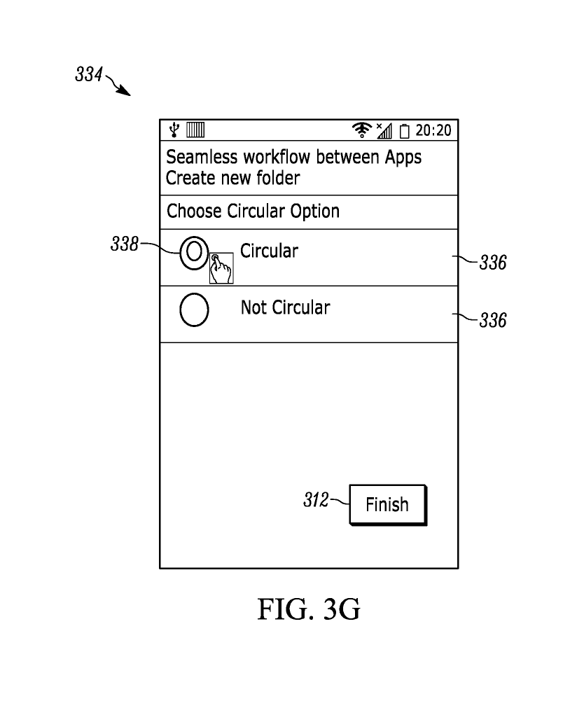

FIG. 2 illustrates an example method 200 for moving between applications on the portable electronic device 100. As an example, the method 200 is described as being performed by the portable electronic device 100 and, in particular, the electronic processor 102. However, it should be understood that in some embodiments, portions of the method 200 may be performed by other devices, for example a remote computing device communicatively coupled to the portable electronic device 100 via one or more communication networks. For ease of description, the method 200 is described in terms of a set of two applications within a single folder. However, it should be understood embodiments of the method 200 may be used with more than two applications, in multiple folders, or both. Additionally, FIGS. 3A through 3G illustrate embodiments of the method 200 and are described in terms of creating a new folder and navigation configuration for navigating through applications within the folder. It should be understood such embodiments may also be used to modify an already existing folder.

In some embodiments, the method 200 includes an initial step of creating one or more folders. FIG. 3A illustrates an example graphical user interface folder screen 300 listing the existing folders 302 and 304 presented on the display 112. In some embodiments, the folders can be created or removed by a user of the portable electronic device 100, for example, by selecting a create folder option 306. In further embodiments, the folders are installed on the portable electronic device 100 via a configuration command from a remote system.

In some embodiments, the folder is able to be assigned or reassigned an identifier, for example a name. The identifier may be assigned by a user via the interface of the portable electronic device 100 or predetermined based on a configuration command from a remote system. FIG. 3B illustrates an example graphical user interface folder identifier screen 308 presented on the display 112. The folder identifier screen 308 provides a folder name option 310 which the user can select to name the folder and a confirmation option 312, which is used to confirm the identifier and continue with the method 200. The folder identifier may later be modified in a similar way described above.

Returning to FIG. 2, at block 202, the electronic processor 102 associates a set of applications, for example the first application 116 and the second application 118 to each other, within the folder 114. In some embodiments, the electronic processor 102 receives, via the interface of the portable electronic device 100, a user selection indicating how many folders to create and which applications to associate with which folder. FIG. 3C illustrates an example graphical user interface folder association screen 314 presented on the display 112. The folder association screen 314 includes a plurality of applications 316 to associate with the present folder. The user selects a set of applications 318 from the plurality of applications 316 and then selects the confirmation option 312 to confirm the selection and continue with the method 200. In further embodiments, the electronic processor 102 receives, through the input and output interface 106, a configuration command from a remote system, for example a computer aided dispatch (CAD) server, indicates which applications to associate with the folder 114. The applications associated with the folder may later be modified in a similar way as described above.

Returning to FIG. 2, at block 204, the electronic processor 102 assigns each application of the set of applications a priority relative to each other. Assigning a priority to each of the applications organizes the set of applications into a priority ordered set. For example, the first application 116 is assigned a first priority. The second application 118 then is assigned a second priority lower than the first priority of the first application 116. In some embodiments, the electronic processor 102 receives, via the interface of the portable electronic device 100, a user selection indicating what priority to assign each application of the set of applications. FIG. 3D illustrates an example graphical user interface application priority screen 320 presented on the display 112. The application priority screen 320 includes the set of applications 318 within the current folder being created or modified and the confirmation option 312, which is used to confirm the selection and continue with the method 200. In further embodiments, the electronic processor 102 receives, through the input and output interface 106, a configuration command from a remote system, for example an emergency dispatch server, of what priority each application of the set of applications 318 is assigned.

At block 206, the electronic processor 102 receives, via the interface of the portable electronic device 100, a first user input selecting the folder 114. In response to receiving the first user input, the set of applications within the folder 114 activates in the background of the operating system 113 of the portable electronic device 100 (block 208) and the electronic processor 102 presents via the display, a first indication of the first application based on the priority of the first application relative to the other applications of the set of applications. For example, the indication of the application with the highest priority (in this case, the second application 118) of the set of applications is presented on the display 112 of the portable electronic device 100 (block 209). The indication may be an icon associated with or a graphical view of the application or the application itself

At block 210, the portable electronic processor 102 receives, via the interface of the portable electronic device 100, a second user input. In response to the second user input, the electronic processor 102 navigates to another indication of another application, for example the second application 118, within the folder based on the priority of the application relative to the other applications within the set of applications and a navigation direction associated with the second user input (block 212). In some embodiments, the electronic processor 102 is configured to determine a gesture type of the second user input. The gesture type may be one of either a first gesture type or a second gesture type. Gesture types include a left slide or swipe, a right slide or swipe, a single tap, a double tap, a circular gesture, and a custom gesture, all of which may be performed with a single finger or two fingers. This should not be considered limiting. In other embodiments, gestures may be received using virtual or augmented reality systems, which detect, for example, the movement of the eyes, arms, hands, or fingers.

The gesture type corresponds to the navigation direction of the set of application. The electronic processor 102 may be configured to associate the first gesture type with a first navigational direction of decreasing priority and the second gesture type with the second navigational direction of increasing priority. The electronic processor 102 determines if the gesture type is of a first gesture type or of a second gesture type. When it is determined that the gesture includes the first gesture type, the electronic processor 102 navigates to and displays on the display 112 an indication of the next application of the priority ordered set assigned a priority lower than the priority of the present application. Alternatively, when it is determined the gesture includes the second gesture type, the electronic processor 102 navigates to and displays on the display 112 an indication of the next application of the priority ordered set assigned a priority less than the priority of the present application.

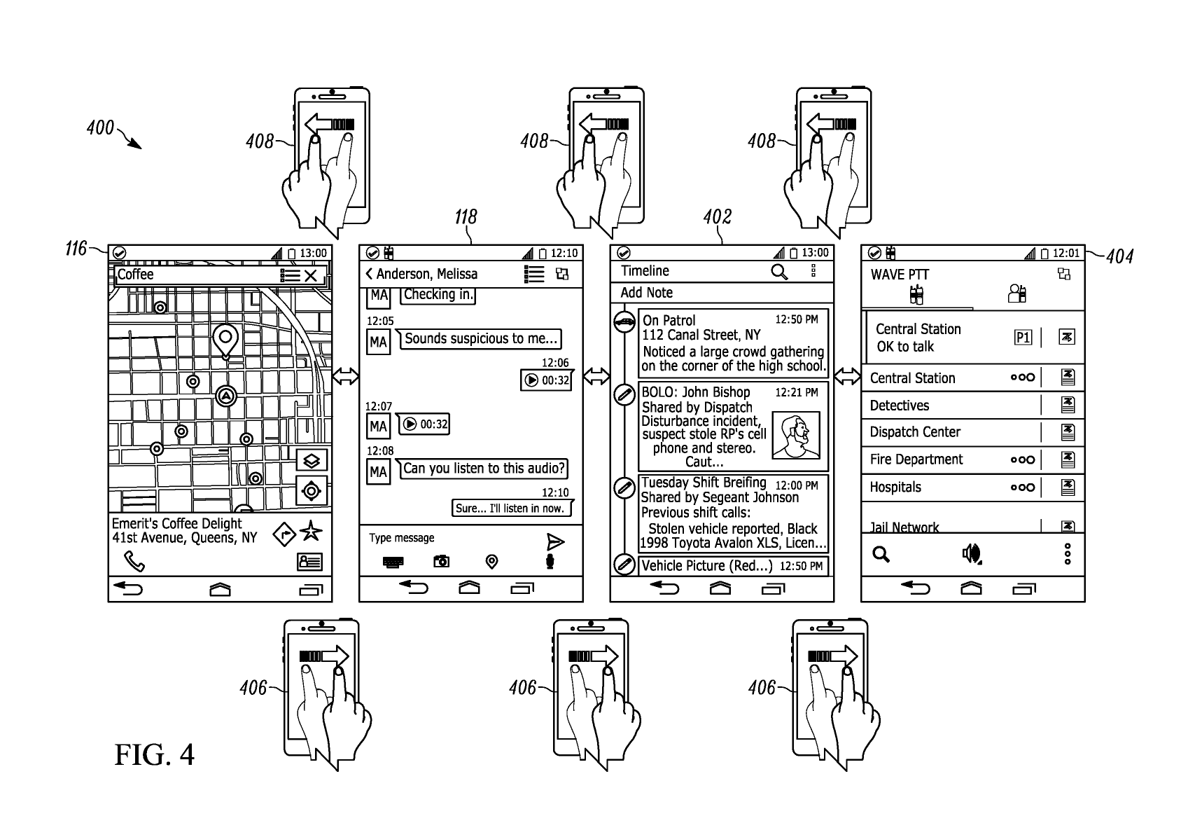

FIG. 4 is a diagram 400 illustrating the navigation between applications on the display 112 of the portable electronic device 100. The diagram 400 illustrates the first application 116, the second application 118, a third application 402, and a fourth application 404. The applications 116, 118, 402, and 404 are all associated with a folder and accordingly form a priority ordered set. The applications 116, 118, 402, and 404 are illustrated, from left to right, in order of increasing priority. In other embodiments, the applications 116, 118, 402, and 404 are arranged in order of decreasing priority. A gesture received by the display 112 navigates, in a corresponding navigational direction, from the application present on the screen to a next application based on the priority. For example, when the current indication is of the second application 118 and the electronic processor 102 receives, via the display 112, a user input, the electronic processor 102 presents on the display 112 an indication of the next application, in order of priority, based on the gesture type of the user input and corresponding navigational direction. The gesture may be one of either a first gesture type 406 or a second gesture type 408. In this example, the first gesture type 406 is a swipe to the right (navigating to application 402) and the second gesture type 408 is a swipe to the left (navigating to application 116).

In some embodiments, the electronic processor 102 receives, via the interface of the portable electronic device 100 (in the example described, the display 112), a user selection of the gesture or gesture types to associate with the first navigational direction and the second navigational direction. FIG. 3E illustrates an example graphical user interface gesture method selection screen 322 presented on the display 112. The gesture method selection screen 322 includes a list of gesture methods 324. The gesture entries within the list of gesture methods 324 may include, for example, a left slide, a right slide, a single tap, a double tap, a circular gesture, and a custom gesture. In some embodiments, the gesture entries within the list of gesture methods 324 each include the first gesture method and the second gesture method. After a gesture entry 326 is selected by the user and the confirmation option 312 is selected, a graphical user interface gesture configuration screen 328 (see FIG. 3F) is presented on the display 112. The gesture configuration screen 328 includes the selected gesture entry 326 and a first and a second navigational option 330, 332 of the first and the second navigational direction. The user selects the first navigational option 330 or the second navigational option 332 to associate the corresponding navigational direction with the gesture. In some embodiments, when the gesture entry 326 includes the first gesture method and the second gesture method, the first navigational option 330 and the second navigational option 332 are provided for the first gesture method and the second gesture method, as shown in FIG. 3F. However, the navigational direction associated with one of the gesture methods cannot be the same as the other gesture method. In further embodiments, the electronic processor 102 receives, through the input and output interface 106, a configuration command from a remote system, for example an emergency dispatch server, of the gesture or gesture types to associate with the first navigational direction and the second navigational direction.

In some embodiments, the electronic processor 102 receives a user input selecting a scrolling type from a group of types. In one example, the group of scrolling types includes either a circular (wrap around) list and a first to last list. When the scrolling type is a first to last list, and the electronic processor 102 receives a gesture navigating in a priority direction past the last indication of the priority ordered set, the last indication remains present on the display 112 unless the gesture corresponds to the opposite direction of priority. When the scrolling type is a circular list, when the electronic processor 102 receives a gesture navigating in a priority direction past the last indication of the priority ordered set, the electronic processor 102 “circles back” to the first indication at the top of the priority ordered set. The scrolling between applications may be in a vertical direction or a horizontal direction. In some embodiments, the scrolling method is selected by a user of the portable electronic device 100, for example, by selecting a create folder option 306. FIG. 3G illustrates an example graphical user interface scrolling selection screen 334. The scrolling selection screen 334 includes a list of scrolling types 336. Once a scrolling type 338 is selected from the scrolling type list 336, the confirmation option 312 is selected to establish the selected scrolling type 338. In further embodiments, the scrolling method is preconfigured via a configuration command from a remote system.

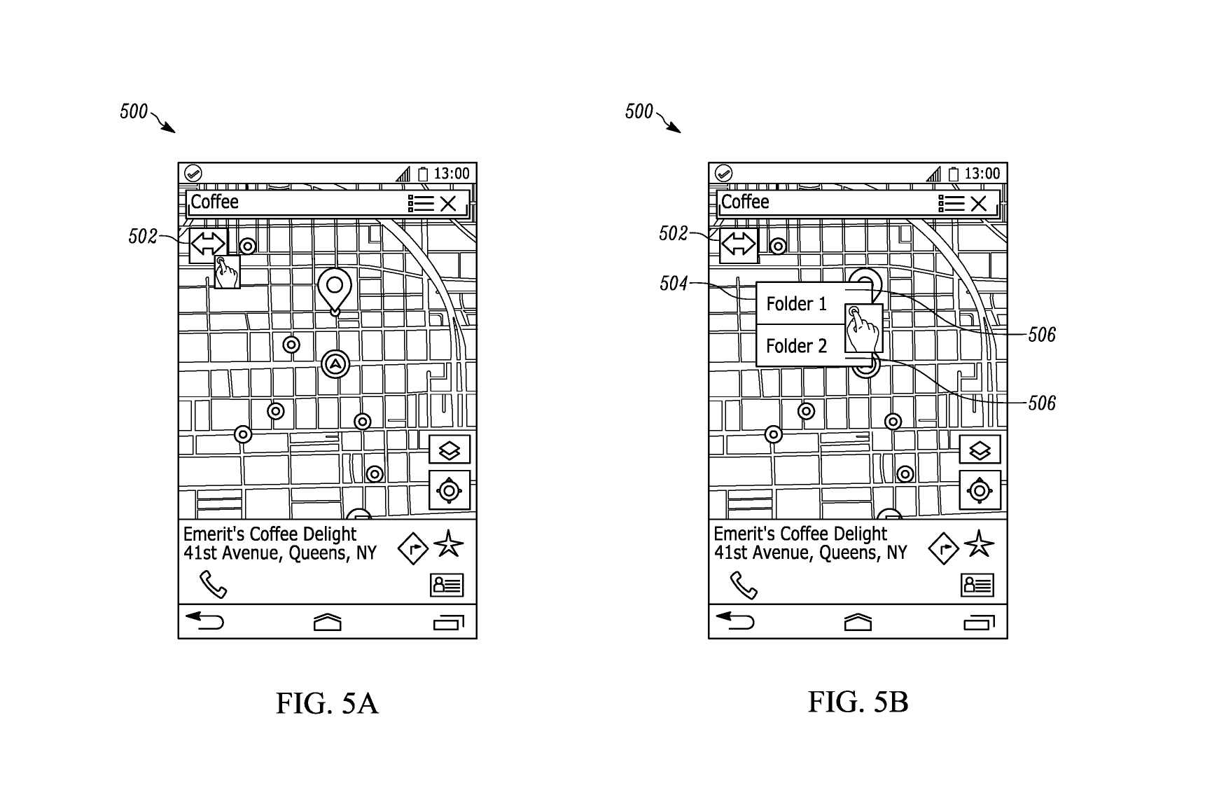

FIG. 5A illustrates an example of navigation between applications within an application screen 500. The electronic processor 102 receives, via the interface of the portable electronic device 100, a user input selecting a menu indicator 502 superimposed within the output of the application selected (that is, the application screen 500). As shown in FIG. 5B, in response to the user input, the electronic processor 102 displays a menu 504 including a set of saved folders identifiers 506. A folder from the set of saved folders identifiers 506 may then be selected to be executed.

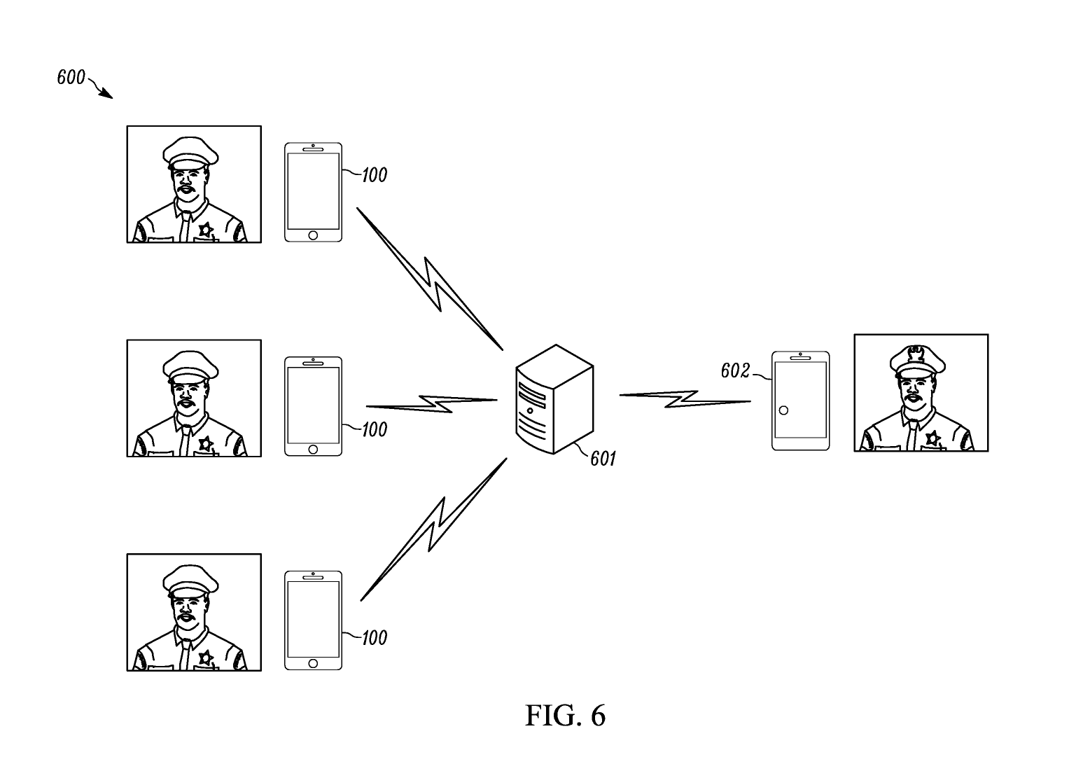

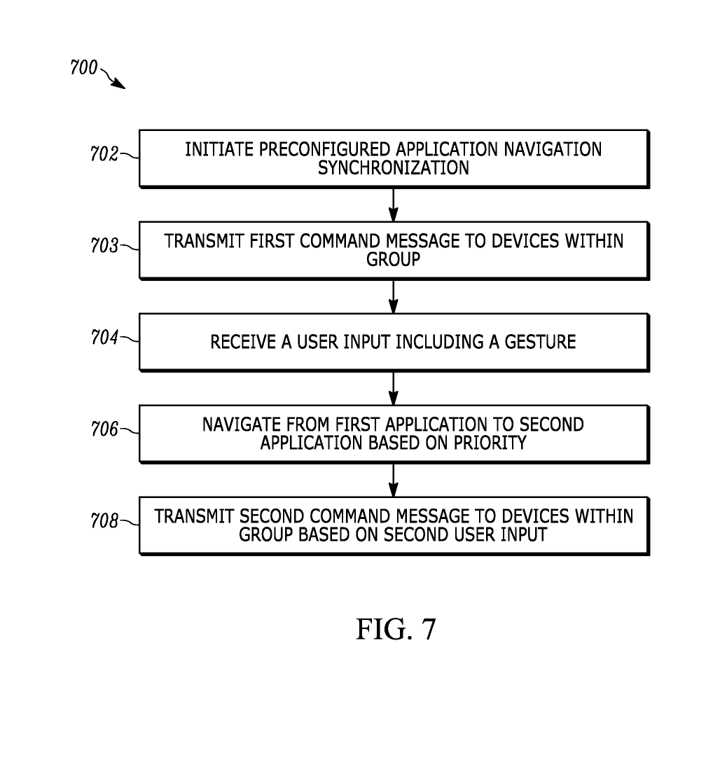

In some embodiments, the electronic processor 102 is configured to implement the method 200 collaboratively across multiple portable devices used by groups of related users. FIG. 6 illustrates a group of related users 600 each of which include the portable device 100. The group of related users 600 may be, for example, emergency personnel, police officers, or other first responders. The portable devices 100 may communicate with each other directly or through a server 601. At least one of the portable devices 100 includes a preconfigured application navigation. The preconfigured application navigation includes a folder of applications and a configured priority navigation created according to the method 200). One of the portable devices 100 within the group of related users 600 is designated as a commanding device 602. As explained in more detail in regards to FIG. 7, the commanding device 602 is configured to share its preconfigured application navigation with the other portable devices 100.

FIG. 7 illustrates a method 700 of sharing a preconfigured application navigation within the group of related users 600. In the example provided the commanding device 602 initiates a preconfigured application navigation synchronization, at block 702. The preconfigured application navigation synchronization is a series of commands that configure the commanding device 602 and the other portable devices 100 within the group of related users 600 to share the preconfigured application navigation on the commanding device 602. In some embodiments, the commanding device 602 sends the commands for the preconfigured application navigation synchronization to the other portable devices 100 through the server 601. In some embodiments, the preconfigured application navigation synchronization involves commanding the other portable devices 100 to create the folder of applications and the configured priority navigation. In some embodiments, when the commanding device 602 has the first application open, the preconfigured application navigation synchronization sends a command message to the other portable devices 100 causing the other portable devices 100 to open an indication of the first application on their displays (block 703).

At block 704, the commanding device 602 receives a user input including a gesture. At block 706, the commanding device 602 then navigates from the first indication of the first application to the first indication of the second application based on the priority (as described above in regards to blocks 210 and 212 of FIG. 2). At block 708, the commanding device 602 transmits a command message to the other portable devices 100 within the group of related users 600 based on the user input. The command message causes the other devices 100 within the group of related users 600 to automatically navigate from the second indication of the first application to a second indication of the second application, as described in regards to block 706.

In some embodiments, when another portable device 100 joins the group 600, the new portable device 100 is configured to send a notice message to the commanding device 602 either directly to the commanding device 602 or through the server 601. The commanding device 602 (or the server 601) receives the notice message and adds the portable device 100 to the group 600. Likewise, one of the portable devices 100 within the group 600 may leave the group 600 by sending a stop synchronization message directly to the commanding device 602 or through the server 601. The commanding device 602 (or the server 601) receives the notice message and removes the portable device 100 to the group 600 and no longer sends preconfigured navigation synchronization commands to the portable device 100.

Although the method 700 is describes the commanding device 602 communicating with the other portable devices 100 through the server 601, it should be understood that in some embodiments, the commanding device 602 communicates with the other portable devices 100 directly (without the server 601).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms for example first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) for example microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A portable device comprising:
a display; and
an electronic processor coupled to the display and configured to
associate a set of applications to each other within a folder stored on the portable device;
assign each application of the set of applications a priority relative to the other applications of the set of applications;
receive, via an interface of the portable device, a first user input selecting the folder;
in response to receiving the first user input, activate the set of applications in a background of an operating system of the portable device and present, via the display, a first indication of a first application of the set of applications based on the priority of the first application relative to the other applications of the set of applications;
receive, via the interface of the portable device, a second user input; and
in response to receiving the second user input, navigate to a first indication of a second application of the set of applications based on the priority of the second application relative to the other applications of the set of applications and a navigation direction associated with the second user input.

2. The portable device of claim 1, wherein the electronic processor is further configured to:
initiate a preconfigured application navigation synchronization, the preconfigured application navigation synchronization including sending a first command message to at least one other portable device causing the at least one other portable device to present on a display of the at least one other portable device, a second indication of the first application; and
transmit a second command message to at least one other portable device based on the second user input, wherein the second command message causes the at least one other portable device to automatically navigate from the second indication of the first application to a second indication of the second application.

3. The portable device of claim 1, wherein the electronic processor associates the set of applications to each other within the folder in response to at least one of selected from the group consisting of receiving a user selection and receiving a configuration command from a remote system.

4. The portable device of claim 1, wherein the electronic processor assigns each application of the set of applications the priority based on at least one of selected from the group consisting of a received user selection and received configuration command from a remote system.

5. The portable device of claim 1, wherein he electronic processor is further configured to:
determine a gesture type of the second user input; and
associate the first gesture type with a first navigation direction of decreasing priority and the second gesture type with a second navigation direction of increasing priority;
wherein the second indication of the second application navigated to is of an application of a lower priority when the gesture type is of the first gesture type and an application of higher priority when the gesture type is of the second gesture type.

6. The portable device of claim 5, wherein determining the gesture includes at least one of selected from the group consisting of receiving a user selection and receiving a configuration command from a remote system.

7. The portable device of claim 5, wherein the first gesture type and second gesture type are each one selected from the group consisting of a left slide, a right slide, a single tap, a double tap, a circular gesture, and a custom gesture.

8. The portable device of claim 1, wherein the electronic processor is further configured to:
receive, via the interface of the portable device, a third user input corresponding to a menu indicator superimposed on an output of the first application; and
in response to the third user input, display on the display a menu including a set of saved folder identifiers including an identifier associated with the folder.

9. The portable device of claim 1, wherein the electronic processor is further configured to receive a user input selecting a scrolling type.

10. A method of application navigation on a portable device, the method comprising:
associating a set of applications to each other within a folder stored on the portable device;
assigning each application of the set of applications a priority relative to the other applications of the set of applications;
receiving, via an interface of the portable device, a first user input selecting the folder;
in response to receiving the first user input, activating the set of applications in a background of an operating system of the portable device and presenting a first indication of a first application of the set of applications based on the priority of the first application relative to the other applications of the set of applications;
receiving, via the interface of the portable device, a second user input including a gesture; and
in response to receiving the second user input, navigating to a second indication of a of a second application of the set of applications based on the priority of the second application relative to the other applications of the set of applications and a navigation direction associated with the second user input.

11. The method of claim 10 further comprising:
initiating a preconfigured application navigation synchronization the preconfigured application navigation synchronization including sending a first command message to at least one other portable device causing the at least one other portable device to present on a display of the at least one other portable device, a second indication of the first application; and
transmitting a second command message to at least one other portable device based on the second user input, wherein the second command message causes the at least one other portable device to automatically navigate from the second indication of the first application to a second indication of the second application.

12. The method of claim 10, wherein associating the set of applications to each other within the folder stored on the portable device includes at least one selected from the group consisting of receiving a user selection and receiving a configuration command from a remote system.

13. The method of claim 10, wherein assigning each application of the set of applications the priority includes at least one of selected from the group consisting of receiving a user selection and receiving a configuration command from a remote system.

14. The method of claim 10, the method further comprising:
determining a gesture type of the second user input; and
associating a first gesture type with a first navigation direction of decreasing priority and the second gesture type with a second navigation direction of increasing priority;
wherein the second indication of the second application navigated to is of an application of a lower priority when the gesture type is of the first gesture type and an application of higher priority when the gesture type is of the second gesture type.

15. The method of claim 10, wherein determining the gesture includes at least one selected from the group consisting of receiving a user selection and receiving a configuration command from a remote system.

16. The method of claim 10, wherein the first gesture type and second gesture type are each one selected from the group consisting of a left slide, a right slide, a single tap, a double tap, a circular gesture, and a custom gesture.

17. The method of claim 10, further comprising:
receiving, via the interface of the portable device, a third user input corresponding to a menu indicator superimposed on an output of the first application; and
in response to the third user input, displaying, on a display of the portable device, a menu including a set of saved folder identifiers including an identifier associated with the folder.

18. The method of claim 10, further comprising selecting a scrolling type.
